(19) United States
(12) Patent Application Publication
(10) Pub. No.: US 2015/0225602 A1
(43) Pub. Date: Aug. 13, 2015

(54) Bisphenol-A Free Epoxy System for Potable Water Pipes, FRP Laminates, and Tanks.

(71) Applicants: Jeff Bassman, Carlsbad, CA (US); Mark MacDonald, Stuart, FL (US)

(72) Inventors: Jeff Bassman, Carlsbad, CA (US); Mark MacDonald, Stuart, FL (US)

(21) Appl. No.: 14/175,024

(22) Filed: Feb. 7, 2014

(51) Int. Cl. C09D 163/00

(52) U.S. Cl. CPC C09D 163/00

(57) ABSTRACT

Bisphenol-A Free Epoxy System for potable water pipes, FRP laminates, and tanks is disclosed. By not incorporating Bis-A in the materials, and by using a certified process that does not cross contaminate the BPA free material with equipment and processes used to produce Bis-A containing epoxy, the hazard of released BPA into the drinking water system is mitigated.

### STATEMENT OF PRIORITY

This application claims priority from Provisional Application 61/762,452 filed Feb. 8, 2013.

### FIELD OF THE INVENTION

This invention relates to methods of constructing water potable systems without introducing hazardous bisphenols by-products.

### BACKGROUND OF THE INVENTION

Bisphenol-A (BPA) in potable water is a health hazard which can lead to reproductive harm, breast cancer, prostate cancer, heart disease, and diabetes. Conventional epoxy coatings and epoxy FRP laminates used to protect and/or rehabilitate water conveyances contain Bisphenol-A and consequently release BPA into the potable (drinking) water system.

Epichlorohydrin is used in combination with EPA in the production of the above epoxy coatings and laminates as well as various resins and other polymers utilized in the manufacture of water treatment, delivery and storage systems. During manufacturing of the epichlorohydrin-based polymeric coagulant aids, a small amount of epichlorohydrin may remain in the coagulant aids as an impurity. When these coagulant aids are used in water treatment, there is a potential for residual epichlorohydrin to be introduced in water. Finished water may also contain epichlorohydrin because of raw water contamination from other uses of epichlorohydrin and because of leaching from epichlorohydrin based components and materials used in drinking water treatment, storage and distribution.

Conventional epoxy systems based on Bis-A currently used to produce coatings and FRP laminates for the potable water industry release BPA into the water system.

By not incorporating Bis-A in the materials, and by using a certified process that does not cross contaminate the material with equipment and processes used to produce Bis-A containing epoxy, the hazard of released BPA into the drinking water system is mitigated.

Substitutes for BPA, labeled BPA-free, have proven less than satisfactory to date. For instance, Use of bisphenol-S (BPS) in products formerly produced with BPA results in many of the same health risks and disadvantages incurred in BPA use.

The invention claimed here solves the above problem. Certified BPA free epoxy is used to produce linings, coatings and FRP laminates that do not contain BPA and therefore eliminate any BPA being released into the water system(s) where they are used.

The claimed invention differs from what currently exists. Certified BPA-free epoxy coatings, linings, and FRP laminates produced using this certified BPA free process and chemistry eliminate any BPA emission. The certified BPA free epoxy chemistry and process of manufacture improve the water impermeability, chemical resistance, and mechanical performance of the coatings or FRP laminates produced for the potable water industry.

This invention is an improvement on what currently exists. The certified BPA-free epoxy coatings, linings, and FRP laminates produced using this certified BPA free process and chemistry eliminate any BPA emission. The certified BPA free epoxy chemistry and process of manufacture improve the water impermeability, chemical resistance, and mechanical performance of the coatings or FRP laminates produced for the potable water industry.

Current epoxy systems used for the protection, construction, and rehabilitation of water conveyances release Bis-A into the water in contact with these materials, which presents the potential health hazard of introducing Bis-A into the water system they are designed to protect. Current epoxy manufacturing techniques and processes are performed on equipment that is used for the production of Bis-A epoxy systems.

By not incorporating Bis-A in the materials, and by using a certified process that does not cross contaminate the material with equipment and processes used to produce Bis-A containing epoxy, the hazard of released BPA into the drinking water system is mitigated.

The certified BPA free epoxy system can be formulated as a coating, lining, FRP laminating resin, VARTM resin, filament winding resin, hand layup resin, vacuum bagging resin, electrical potting compound, insulating material, mortar, grout, pressure or gravity injection material, and for casting resins. The certified BPA free epoxy system could be a component of a medical device, water treatment or purification equipment, in the manufacture of water filtration equipment, storage tanks, and a myriad of other final products such as automobile, rail, air transport, or marine conveyances or parts. It can be used as a conventionally or robotically applied rehabilitation or protective coating or lining. It can be combined as a matrix material with many other substrates to form a composite. It can be used as an adhesive or bonding compound.

### DETAILED DESCRIPTION OF THE INVENTION

1. Do not use epoxy resins based on the reaction of Bisphenol-A with epichlorohydrin. Appropriate substitutes may include the following and their equivalents:
   Bisphenol C 4,4′-(1-methylethylidene)bis(2-methylphenol)
   Bisphenol F 4,4′-di(hydroxydiphenyl)methane
   PHBB Benzyl 4-hydroxybenzoate; Benzylparaben (BzP)
   MBHA Methyl bis(4-hydroxyphenyl)acetate
   BisOPP-A 2,2-bis(2-hydroxy-5-biphenylyl)propane
   2,4′-Bisphenol-S 2,4′-Dihydroxydiphenyl sulfone
   TGSA Bis-(3-allyl-4-hydroxyphenyl) sulfone
   BPS-MAE 4-[[4-(2-propen-1-yloxy)phenyl]sulfonyl]phenol
   BPS-MPE4-[(4-Benzyloxyphenyl)sulfonyl]phenol
2. Do not use epoxy curing agents which contain any Bis-A ingredients.
3. No curing agent adducts may be produced by using epoxy resin based on Bis-A.
4. Epoxy raw materials must be made on equipment where no Bis-A based epoxy resin or curing agent is manufactured or processed.
5. Do not store any of the certified BPA free epoxy system ingredients in tanks where BPA containing chemicals are stored.
6. The production facility where certified BPA free epoxy is made must be completely separated from any areas where epoxy or curing agents containing Bis-A are processed, stored or used.
7. Do not store or transport the certified BPA free epoxy in the same containers where epoxy or curing agents made with Bis-A have been stored previously unless the storage or transport system is completely cleaned of any BPA containing material.
8. All production equipment used in the certified BPA free process must be dedicated to the production of BPA free epoxy systems.
9. Raw materials sourced from others must be audited to ensure that no BPA has been introduced into the manufacturing process of the raw materials used in the production of the certified BPA free epoxy system discussed herein.

Steps 1-8 ensure that no BPA containing raw materials are used in the development, manufacture, and storage of the certified BPA free epoxy system. This is the simplest method of assuring that no BPA is present in the final epoxy system produced. Step 9 ensures that no raw material produced by others and included in the manufacture of the certified BPA free epoxy system contains any BPA.

By following steps 1-9, a certified BPA free epoxy system is produced which does not contain, and therefore can not release BPA when it is used in the construction, rehabilitation, repair, coating, and lining of the potable water system, in the manufacture of devices which are in contact with potable water, and for containers, reservoirs, or tanks used for the storage of potable water.

The certified BPA free epoxy system is formulated as a coating, lining, or FRP laminating system used to protect, rehabilitate, convey and/or store potable water. The certified BPA free epoxy system may be used as a component in the manufacture of a water processing device such as a reverse osmosis filter, pressure vessel or storage tank.

Additionally, the certified BPA free epoxy could be used to manufacture other than water contact conveyances or devices where the lack of emission or presence of BPA in the cured material is desirable. Such applications may include medical device components, water treatment or purification equipment, in the manufacture of water filtration equipment, storage tanks, and a myriad of other final products such as automobile, rail, air transport, or marine conveyances or parts. It can be used as a conventionally or robotically applied rehabilitation or protective coating or lining. It can be combined as a matrix material with many other substrates to form a composite. It can be used as an adhesive or bonding compound.

What is claimed:

1. A method of ensuring BPA-free construction or repair of water treatment, distribution or storage systems comprising the steps of:
Selecting a non-Bisphenol-A epoxy resin for construction or repair of water vessels or distribution or storage systems from the group including Bisphenol-F, Bisphenol-C, MBHA, BisOPP-A, 2,4′-Bisphenol-S, TGSA, BPS-MAE and BPS-MPE;
Selecting a non-Bisphenol-A epoxy curing agent for construction or repair of water vessels or distribution or storage systems;
Selecting a mixing platform cleansed or free of Bisphenol-A resins and agents; and
Combining all resins and agents in said mixing platform for transfer to storage or production facilities cleansed and physically separated from prior exposure to Bisphenol-A resins and agents.
